(19) United States
(12) Patent Application Publication
(10) Pub. No.: US 2008/0292329 A1
(43) Pub. Date: Nov. 27, 2008

(54) DRIVER APPARATUS, SHEET ARRANGEMENT MANAGEMENT METHOD, SHEET ARRANGEMENT MANAGEMENT PROGRAM

(75) Inventors: Yuko Kimoto, Kanagawa-ken (JP); Naoki Hoshino, Saitama-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/753,614

(22) Filed: May 25, 2007

(51) Int. Cl. G03G 15/00

(52) U.S. Cl. 399/17

(57) ABSTRACT

To provide a technique that improves, when image processing is applied to a special sheet for which an arrangement method needs to be taken into account, operability of arrangement operation for the special sheet to be printed.

A driver apparatus that causes an image processing apparatus to execute predetermined image processing on a sheet includes a sheet discriminating unit that discriminates a type of a sheet to be subjected to the predetermined image processing, an arrangement-information acquiring unit that acquires arrangement information associated with the sheet discriminated by the sheet discriminating unit, the arrangement information being arrangement information concerning a predetermined arrangement in the image forming apparatus of the sheet for causing the image forming apparatus to execute the predetermined image processing, and an arrangement displaying unit that displays, on the basis of the arrangement information acquired by the arrangement-information acquiring unit, the predetermined arrangement in the image processing apparatus of the sheet discriminated by the sheet discriminating unit.

### BACKGROUND OF THE INVENTION

1. Field of the Invention

The present invention relates to an image processing technique for a special sheet, and, more particularly to a technique for improving operability of arrangement operation for a special sheet to be printed.

2. Description of the Related Art

Conventionally, there is known a technique for applying image processing to a special sheet, a method of arrangement of which in sheet feeding trays and the like is limited, in an image processing apparatus.

However, in the conventional technique, since there is no setting item concerning a direction of the special sheet on a driver screen for instructing execution of the image processing, it is difficult to grasp, until the special sheet is actually printed, in which direction the special sheet is printed.

It is impossible to confirm during setting on the driver screen whether an arrangement direction of the special sheet and a direction of an image to be printed coincide with each other. Thus, there is no other way but to confirm this by actually printing the image with a trial print function (a so-called test printing function).

### SUMMARY OF THE INVENTION

It is an object of an embodiment of the invention to provide a technique that improves, when image processing is applied to a special sheet for which an arrangement method needs to be taken into account, operability of arrangement operation for the special sheet to be printed.

In order to solve the problem, a driver apparatus according to an aspect of the invention is a driver apparatus that causes an image processing apparatus to execute predetermined image processing on a sheet. The driver apparatus is characterized by including a sheet discriminating unit that discriminates a type of a sheet to be subjected to the predetermined image processing, an arrangement-information acquiring unit that acquires arrangement information associated with the sheet discriminated by the sheet discriminating unit, the arrangement information being arrangement information concerning a predetermined arrangement in the image forming apparatus of the sheet for causing the image forming apparatus to execute the predetermined image processing, and an arrangement displaying unit that displays, on the basis of the arrangement information acquired by the arrangement-information acquiring unit, the predetermined arrangement in the image processing apparatus of the sheet discriminated by the sheet discriminating unit.

A sheet arrangement management method according to another aspect of the invention is a sheet arrangement management method for managing, in a driver apparatus that causes an image processing apparatus to execute predetermined image processing on a sheet, a sheet arrangement in the image processing apparatus. The sheet arrangement management method is characterized by including a sheet discriminating step of discriminating a type of a sheet to be subjected to the predetermined image processing, an arrangement-information acquiring step of acquiring arrangement information associated with the sheet discriminated in the sheet discriminating step, the arrangement information being arrangement information concerning a predetermined arrangement in the image forming apparatus of the sheet for causing the image forming apparatus to execute the predetermined image processing, and an arrangement displaying step of displaying, on the basis of the arrangement information acquired in the arrangement-information acquiring step, the predetermined arrangement in the image processing apparatus of the sheet discriminated in the sheet discriminating step.

A sheet arrangement management program according to still another aspect of the invention is a sheet arrangement management program for causing a computer to execute, in a driver apparatus that causes an image processing apparatus to execute predetermined image processing on a sheet, management of a sheet arrangement in the image processing apparatus. The sheet arrangement management program is characterized by causing the computer to execute a sheet discriminating step of discriminating a type of a sheet to be subjected to the predetermined image processing, an arrangement-information acquiring step of acquiring arrangement information associated with the sheet discriminated in the sheet discriminating step, the arrangement information being arrangement information concerning a predetermined arrangement in the image forming apparatus of the sheet for causing the image forming apparatus to execute the predetermined image processing, and an arrangement displaying step of displaying, on the basis of the arrangement information acquired in the arrangement-information acquiring step, the predetermined arrangement in the image processing apparatus of the sheet discriminated in the sheet discriminating step.

### DESCRIPTION OF THE DRAWINGS

FIG. 1 is a diagram showing a configuration of an image processing system including a PC (including a driver apparatus) 11 and an image processing apparatus 21 according to an embodiment of the invention;

FIG. 2 is an external perspective view for explaining an overview of the image processing apparatus 21 according to the embodiment;

FIG. 3 is a functional block diagram for explaining the PC 11 according to the embodiment;

FIG. 4 is a flowchart for explaining a flow of processing (a sheet arrangement management method) in the PC 11 according to the embodiment;

FIG. 5 is a diagram showing an example of a printer driver screen;

FIG. 6 is a diagram showing an example of a detail setting screen 701d;

FIG. 7 is a diagram showing an example of a special sheet;

FIG. 8 is a diagram showing character information that a user is about to print on the sheet shown in FIG. 7;

FIG. 9 is a diagram showing an example in which an image indicating a state in which a sheet is arranged in a position where the sheet should be arranged in the image processing apparatus is displayed on a display 11a by an arrangement displaying unit 103;

FIG. 10 is a diagram showing an example of the printer driver screen;

FIG. 11 is a diagram showing an example of screen display in the case in which an arrangement state of a sheet is different from a predetermined arrangement;

FIG. 12 is a diagram showing another example of the screen display in the case in which an arrangement state of a sheet is different from the predetermined arrangement;

FIG. 13 is a diagram showing an example in which inconsistency of information to be printed and an arrangement of a sheet occurs;

FIG. 14 is a diagram showing a state in which appropriate print processing is applied to the special sheet;

FIG. 15 is a diagram showing an example in which an indication that “special print setting” is already registered is displayed in a printer driver screen on the interface screen 211 of the image processing apparatus 21;

FIG. 16 is a diagram showing an example of a screen in which setting information is displayed as a list; and

FIG. 17 is a diagram showing an example in which a method of arranging the special sheet is displayed on a screen in the image processing apparatus 21.

### DESCRIPTION OF THE EMBODIMENTS

Embodiments of the invention will be hereinafter explained with reference to the drawings.

### First Embodiment

First, a driver apparatus according to a first embodiment of the invention will be explained.

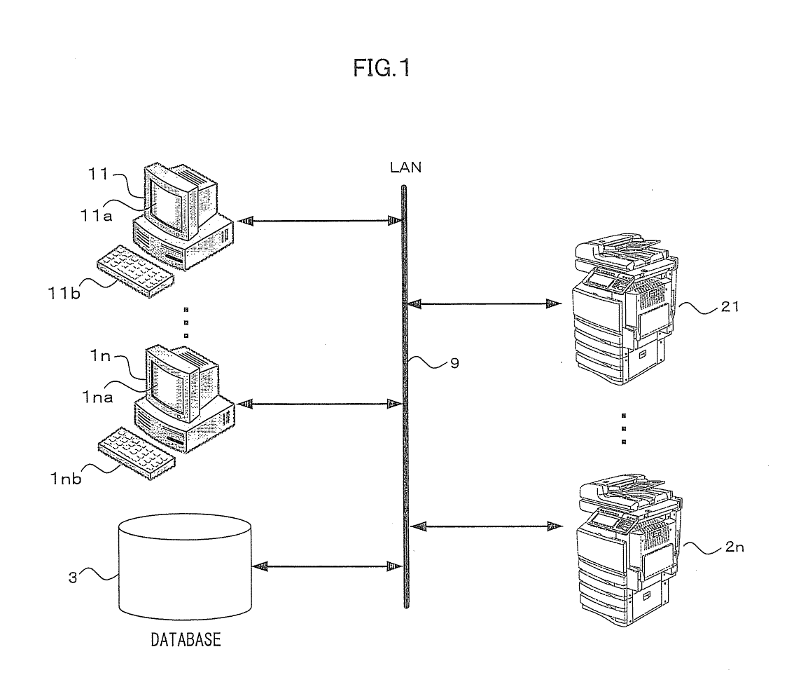

FIG. 1 is a diagram showing a configuration of an image processing system including a PC (including a driver apparatus) 11 and an image processing apparatus 21 according to this embodiment. In the image processing system shown in the figure, PCs (Personal Computers) 11 to 1n, image processing apparatuses 21 to 2n, and a database 3 are connected to be capable of communicating with one another via a telecommunication line such as a LAN 9.

Means for connecting the PCs 11 to 1n, the image processing apparatuses 21 to 2n, and the database 3 to be capable of communicating with one another is explained as the LAN here. However, the means is not limited to this and may be the Internet, a WAN, and the like (the means may be either wired or wireless). The PCs 11 to 1n are capable of performing various kinds of setting concerning an image processing function executable in the image processing apparatuses 21 to 2n and giving, for example, commands for execution of various processing functions to the image processing apparatuses 21 to 2n.

The commands and the like given to the image processing apparatuses 21 to 2n by the PCs 11 to 1n are performed by the driver apparatuses included in the PCs 11 to 1n on the basis of operation inputs performed by users, who look at setting screens displayed on displays 11a to 1na included in the PCs 11 to 1n, using operation inputting units (e.g., keyboards or mouses) 11b to 1nb. The example in which the displays and the operation inputting units are separately provided is cited here. However, the displays and the operation inputting units are not limited to this. For example, the functions of the displays and the operation inputting units may be realized by touch panel displays.

The database 3 has a role of a storage area that stores various kinds of setting information and the like used in the PCs 11 to in and the image processing apparatuses 21 to 2n.

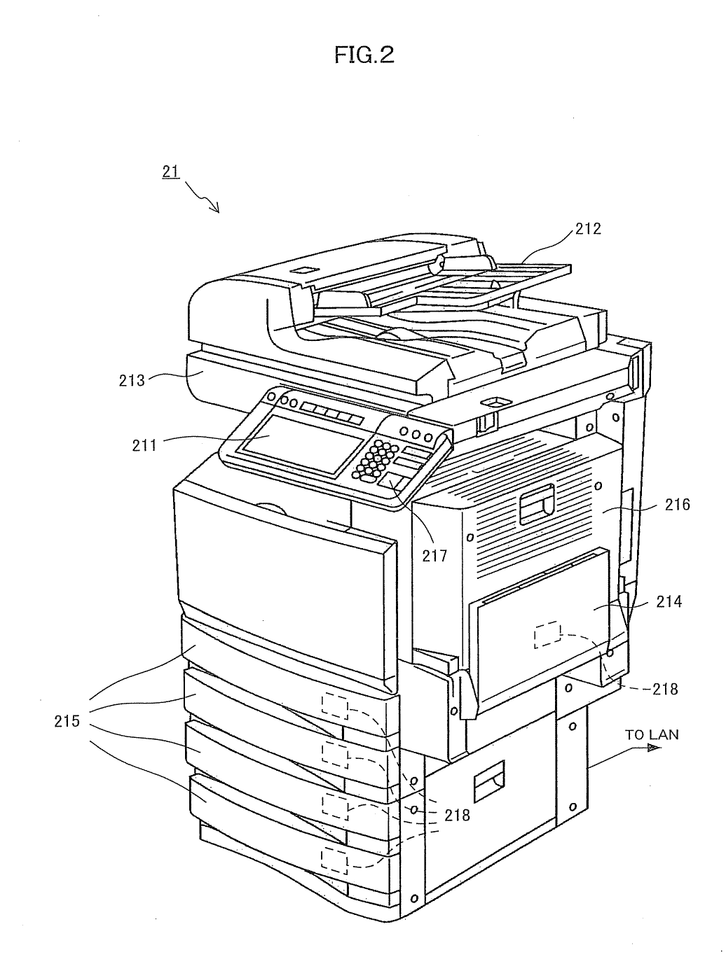

FIG. 2 is an external perspective view for explaining an overview of the image processing apparatus 21 according to this embodiment. Here, as an example, an example in which the image processing apparatus 21 is an MFP (Multi Function Peripheral) is cited.

The image processing apparatus 21 according to this embodiment includes an interface screen 211, an ADF (Auto Document Feeder) 212, an image scanning unit 213, a manual sheet feeing unit 214, sheet feeding cassettes 215, an image forming unit 216, an authentication processing unit 217, and a media sensor 218.

An example of operations of the image processing apparatus 21 according to this embodiment will be hereinafter briefly explained. When, for example, copy processing (predetermined image processing) is performed in the image processing apparatus 21, first, authentication processing for a user is performed by the authentication processing unit 217. Subsequently, an original set in the ADF 212 is automatically conveyed to a position for original scanning by the image scanning unit 213 on the basis of an operation input to the interface screen 211 by the user who has succeeded in the authentication processing. An image of the original conveyed in this way is scanned by the image scanning unit 213. A sheet feeding operation is performed by any one of the sheet feeding cassettes 215 and the manual sheet feeding unit 214 according to a sheet feeding method selected on the basis of the operation input to the interface screen 211. A sheet fed is conveyed to the image forming unit (an image processing unit) 216 and applied with image formation processing based on the image scanned by the image scanning unit 213. The copy processing is completed.

The interface screen 211 is constituted by, for example, a touch panel display. The interface screen 211 performs screen display of various kinds of information and also has a role of an operation inputting unit that accepts an operation input of the user based on display contents on the interface screen 211. The media sensor 218 has a function of detecting at least one of a reflectance, an electric resistance, a size, thickness, and surface roughness of a sheet set in a sheet arrangement position of the manual sheet feeding tray 214, the sheet feeding cassette 215, or the like in the image processing apparatus.

The image processing apparatus 21 is capable of executing plural functions different from one another such as a “print function” of performing print processing on the basis of image data acquired by the image processing apparatus 21, a “facsimile function” of transmitting the image data acquired by the image processing apparatus 21 (image data scanned from an original, image data received from an external apparatus, etc.) to a desired destination by facsimile, a “scan function” of scanning an image of the original, and a “box function” of storing the image data scanned from the original by the “scan function” in the image processing apparatus 21 in a desired storage area. The “box function” is capable of selecting, as a data storage destination (a destination), at least any one of the PCs 11 to in and the image processing apparatuses 22 to 2n connected to the image processing apparatus 21 to be capable of communicating with each other. It is possible to realize a copy function by causing the image processing apparatus 21 to execute the “scan function” and the “print function” in combination.

As processing objects of the predetermined image processing in the image processing apparatus 21, a sheet-like recording medium such as a copy sheet, a sheet original, a book original, a book-like original, image data, and the like are cited as examples.

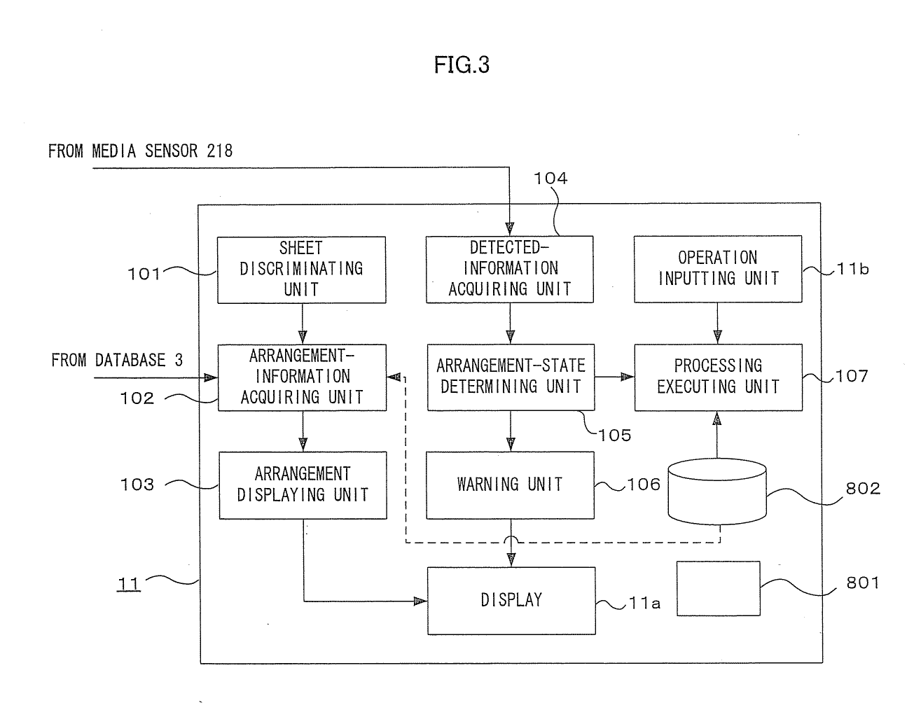

FIG. 3 is a functional block diagram for explaining the PC 11 according to this embodiment. In this embodiment, the PCs 11 to in have the same components. The image processing apparatuses 21 to 2n also have the same components. It is possible to realize the image processing system according to this embodiment with any one of the image processing apparatuses 21 to 2n and any one of the PCs 11 to 1n. Thus, a case in which print processing is executed on a special sheet in the image processing system constituted by the image processing apparatus 21 and the PC 11 will be hereinafter explained in detail as an example.

The PC 11 (equivalent to the driver apparatus) according to this embodiment causes the image processing apparatus to execute plural functions (e.g., the print function, the facsimile function, the scan function, and the box function) executable in the image processing apparatus on the basis of setting contents set in setting screens corresponding to the respective functions. The image processing apparatus 21 and the CP 11 according to this embodiment displays plural setting screens for performing setting for each of the plural functions executable in the image processing apparatus 21, which are plural setting screens (a printer driver screen, a facsimile driver screen, a scanner driver screen, etc.) that can display plural setting items in the respective functions on the respective setting screens, such that selection of the setting screens can be switched.

Specifically, the PC 11 according to this embodiment includes a sheet discriminating unit 101, an arrangement-information acquiring unit 102, an arrangement displaying unit 103, a detected-information acquiring unit 104, an arrangement-state determining unit 105, a warning unit 106, a processing executing unit 107, a CPU 801, and a MEMORY 802.

The sheet discriminating unit 101 discriminates a type of a sheet to be subjected to print processing (predetermined image processing) when a user instructs the image processing apparatus 21 to perform print processing based on desired data.

The arrangement-information acquiring unit 102 acquires arrangement information stored in the database 3 (or a storage device such as the MEMORY 802) in association with characteristic information (information detected by the media sensor) of the sheet discriminated by the sheet-discriminating unit 101, identification information (ID), and the like, which is arrangement information concerning a predetermined arrangement in the image forming apparatus of the sheet for causing the image forming apparatus to execute print processing on the sheet. As the arrangement information here, sound data for announcing a method of arranging the sheet, document data for explaining the method of arranging the sheet, image data visually indicating a proper arrangement state of the sheet, and the like are cited as examples.

The arrangement displaying unit 103 displays the predetermined arrangement in the image processing apparatus 21 of the sheet discriminated by the sheet discriminating unit 101 on the basis of the arrangement information acquired by the arrangement-information acquiring unit 102.

The detected-information acquiring unit 104 acquires information detected from the sheet by the media sensor 218 in the image processing apparatus 21.

The arrangement-state determining unit 105 determines an arrangement state of the sheet on the basis of the detected information acquired by the detected-information acquiring unit 104.

The warning unit 106 performs warning when the arrangement state determined by the arrangement-state determining unit 105 is different from the predetermined arrangement.

The processing executing unit 107 causes, when the arrangement state determined by the arrangement-state determining unit 105 is different from the predetermined arrangement, the image processing apparatus 21 to rotate, according to the arrangement state of the sheet, an image that should be formed on the sheet and execute the print processing.

The CPU 801 has a role of performing various kinds of processing in the PC 11 and also has a role of realizing various functions by executing programs stored in the MEMORY 802. The MEMORY 802 is constituted by, for example a ROM or a RAM and has a role of storing various kinds of information and programs used in the PC 11.

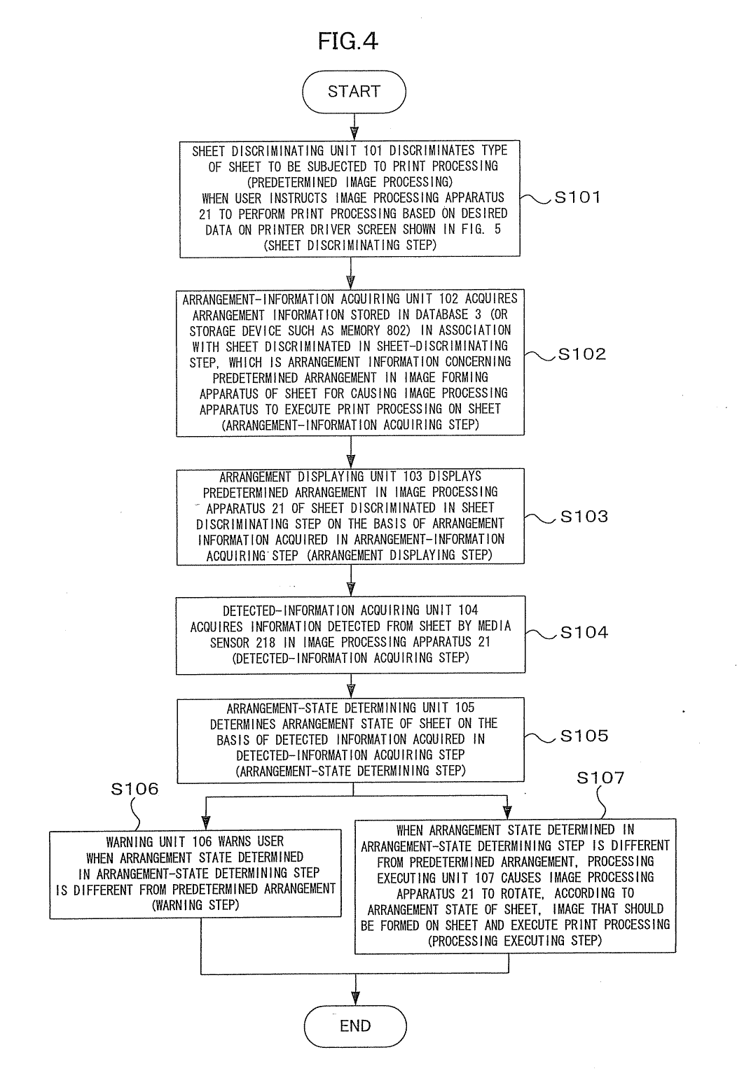

FIG. 4 is a flowchart for explaining a flow of processing (a sheet arrangement management method) in the PC 11 according to this embodiment. Here, a case in which the PC 11 causes the image processing apparatus 2 to execute the print processing is cited as an example.

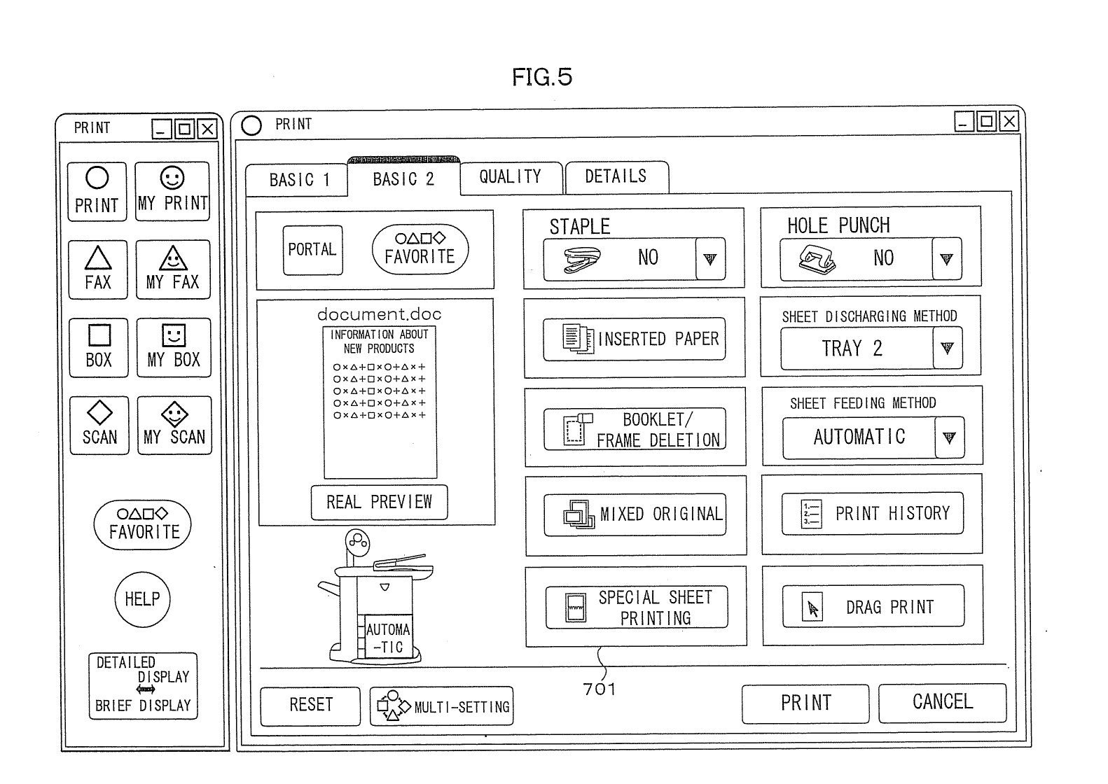

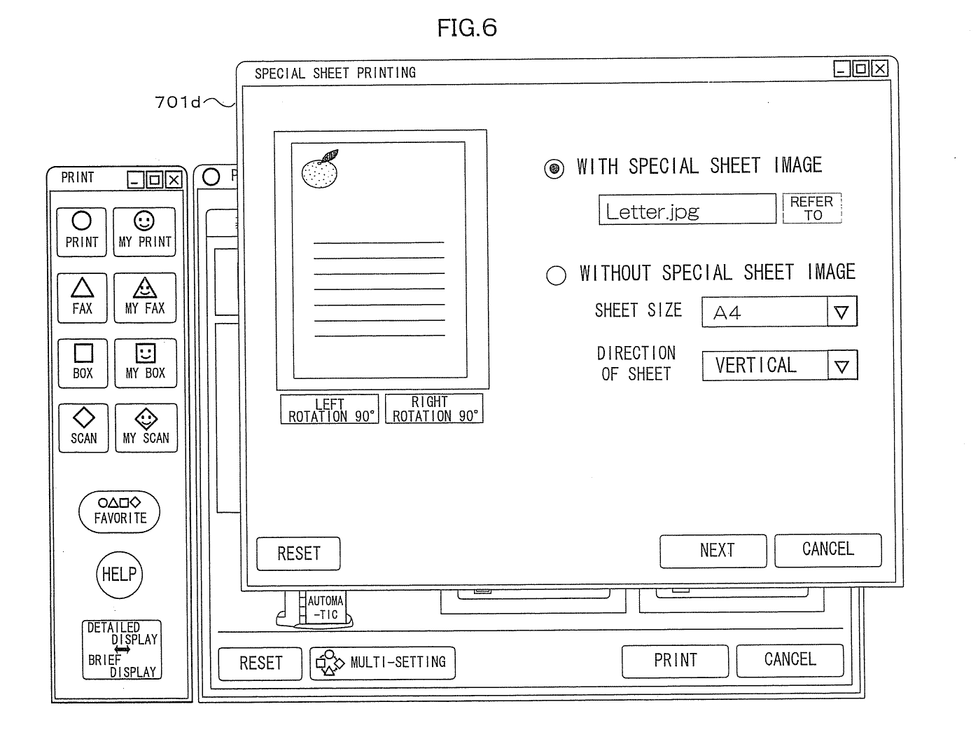

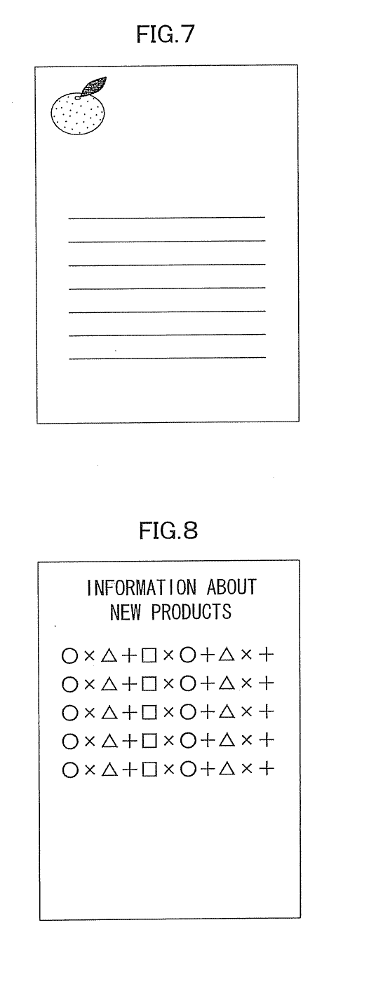

The sheet discriminating unit 101 discriminates a type of a sheet to be subjected to the print processing (the predetermined image processing) when the user instructs the image processing apparatus 21 to perform print processing based on desired data on a printer driver screen shown in FIG. 5 (a sheet discriminating step) (S101). The discrimination of a sheet type here is performed on the basis of, for example, setting information of a special sheet set in a detail setting screen 701d (FIG. 6) displayed on the display 11a by depressing a “Special Sheet Printing” button 701 in the printer driver screen shown in FIG. 5. Here, as an example, it is assumed that the user has selected a sheet shown in FIG. 7 as the special sheet. Besides, as the special sheet, it is possible to select, for example, a sheet on which a company name, a logo, a mark, and the like are printed. FIG. 8 is a diagram showing an example of character information that the user is about to print on the sheet shown in FIG. 7.

The arrangement-information acquiring unit 102 acquires arrangement information stored in the database 3 (or the storage device such as the MEMORY 2) in association with the sheet discriminated in the sheet discriminating step, which is arrangement information concerning a predetermined arrangement in the image forming apparatus of the sheet for causing the image processing apparatus 21 to execute the print processing on the sheet (an arrangement-information acquiring step) (S102). As the arrangement information here, sound data for announcing a method of arranging the sheet, document data for explaining the method of arranging the sheet, image data indicating a proper arrangement state of the sheet, and the like are cited as examples.

Subsequently, the arrangement displaying unit 103 displays the predetermined arrangement in the image processing apparatus 21 of the sheet discriminated in the sheet discriminating step on the basis of the arrangement information acquired in the arrangement-information acquiring step (an arrangement displaying step) (S103).

Specifically, in the arrangement displaying step, information indicating how the sheet discriminated in the sheet discriminating step should be arranged in the sheet feeding cassette 215 or the manual sheet feeding tray 214 (the sheet arrangement position) in the image processing apparatus is displayed on the display 11a. It goes without saying that the display of the arrangement information by the arrangement displaying unit 103 is not limited to the image display on the display 11a and may be, for example, an explanation by display of a sentence that explains arrangement information and sound output (sound indication) performed by using a not-shown speaker. Specifically, the arrangement displaying unit 103 displays, for example, a sentence “please set a sheet in a position indicated by an arrow with a rear surface upward” on a screen when the explanation of the arrangement information is displayed as a sentence.

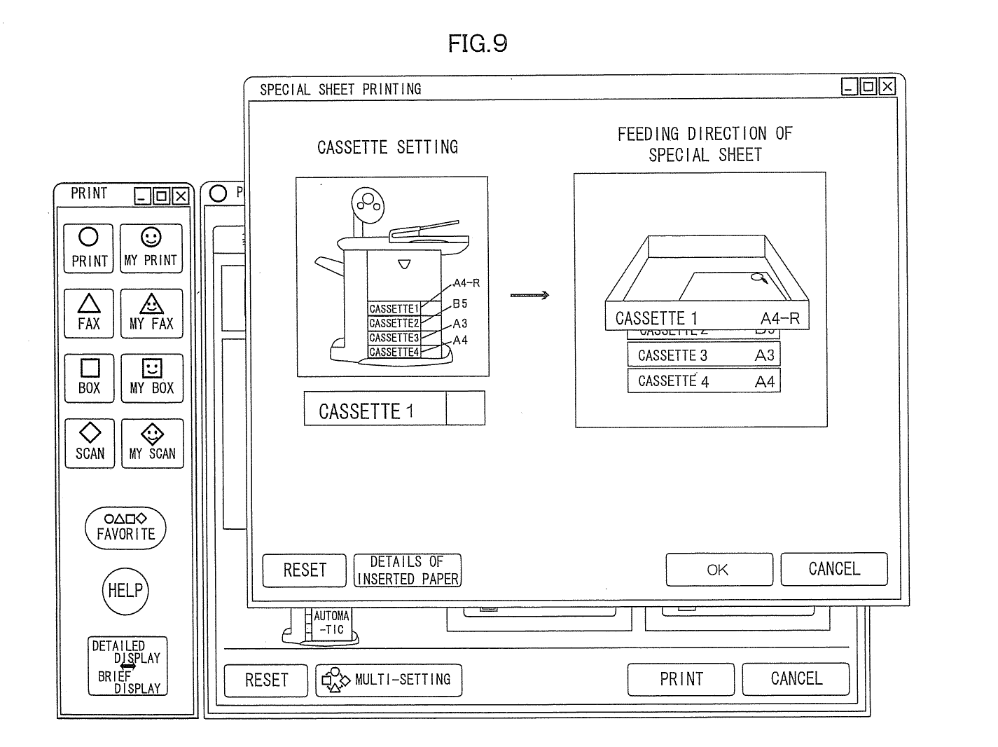

FIG. 9 is a diagram showing an example in which an image indicating a state in which a sheet is arranged in a position where the sheet should be arranged in the image processing apparatus is displayed on the display 11a by the arrangement displaying unit 103. As the image of the sheet displayed on the screen shown in FIG. 9, it is possible to adopt an image scanned by the image scanning unit 213 in the image processing apparatus 21. For example, an image of the sheet scanned by the image scanning unit 213 may be stored in the database 3 and set as a “special sheet image” in the special sheet print setting screen 701d shown in FIG. 6 to refer to the image in the arrangement displaying unit 103.

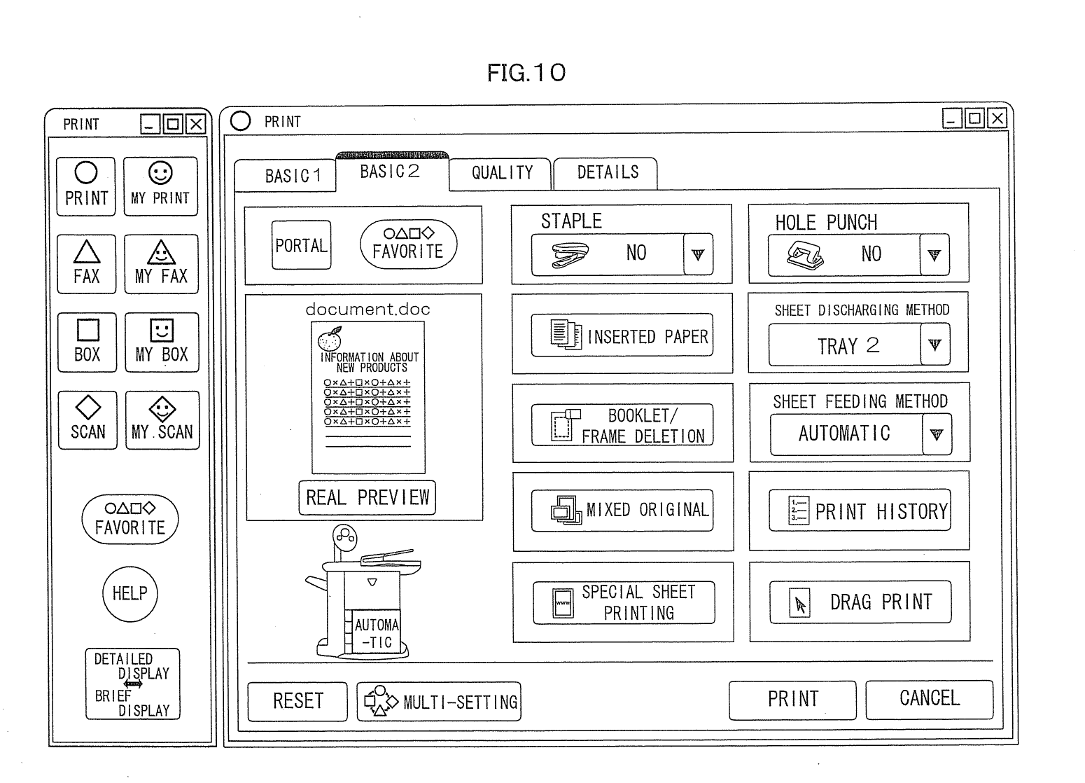

When the sheet is set in the image processing apparatus by the user who refers to the screen shown in FIG. 9 and a print instruction is performed in a printer driver screen shown in FIG. 10, the detected-information acquiring unit 104 acquires information detected from the sheet by the media sensor 218 in the image processing apparatus 21 (a detected-information acquiring step) (S104). On the printer driver screen shown in FIG. 10, a state in which character information to be printed is printed on the sheet selected by the user is displayed as a preview to make it easy for the user to visually grasp setting contents of the user.

Here, the print instruction in the printer driver screen is used as information indicating that the setting of the sheet in the predetermined arrangement position has been completed. However, the information is not limited to the print instruction. An operation input directly indicating that the setting of the sheet has been completed may be requested.

The arrangement-state determining unit 105 determines an arrangement state of the sheet on the basis of the detected information acquired in the detected-information acquiring step (an arrangement-state determining step) (S105). As the arrangement state here, the front and back of the sheet, a tilt of the sheet, a direction of the sheet (a position of an image printed on the sheet in advance), a shape of the sheet (including “bend” and “warp”), and the like are cited as examples.

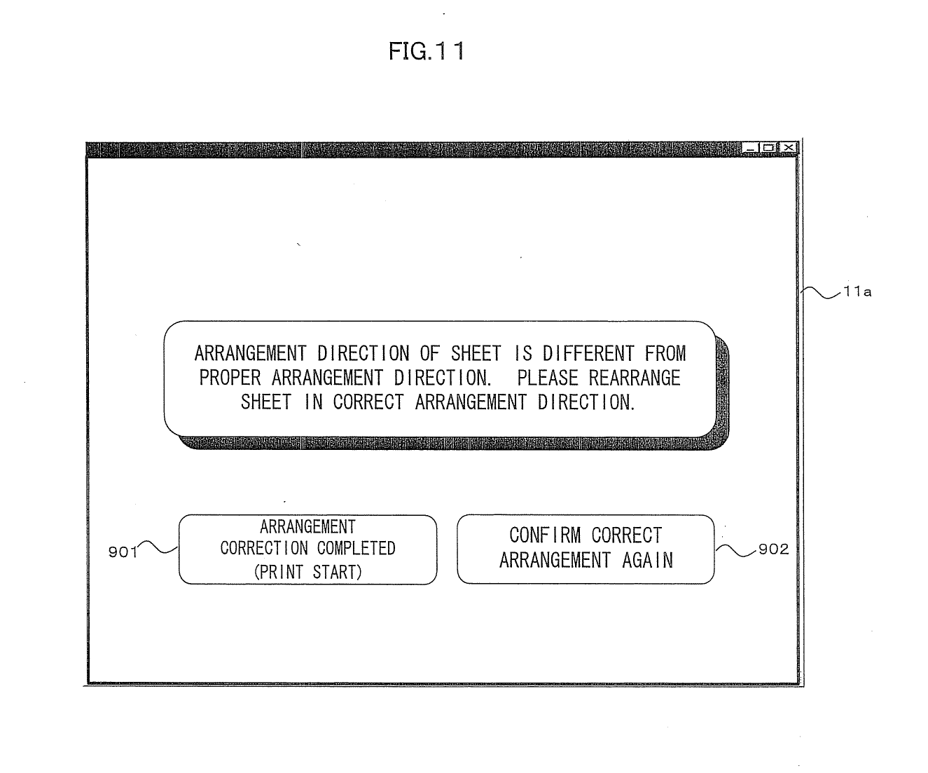

Subsequently, when the arrangement state determined in the arrangement-state determining step is different from the predetermined arrangement, the warning unit 106 displays a screen shown in FIG. 11 on the display 11a to warn the user (a warning step) (S106). When the user selects a “Confirm a Correct Arrangement Again” button 902 in the warning screen shown in FIG. 11, the screen indicating a sheet arrangement method shown in FIG. 9 is displayed. When the user completes correction of a sheet arrangement and selects an “Arrangement Correction Completed” button 901, print processing based on the special print setting is executed.

When the arrangement state determined in the arrangement-state determining step is different from the predetermined arrangement, it is also possible to cause, through the processing executing unit 107, the image processing apparatus 21 to rotate, according to the arrangement state of the sheet, an image that should be formed on the sheet and execute the print processing (a processing executing step) (S107).

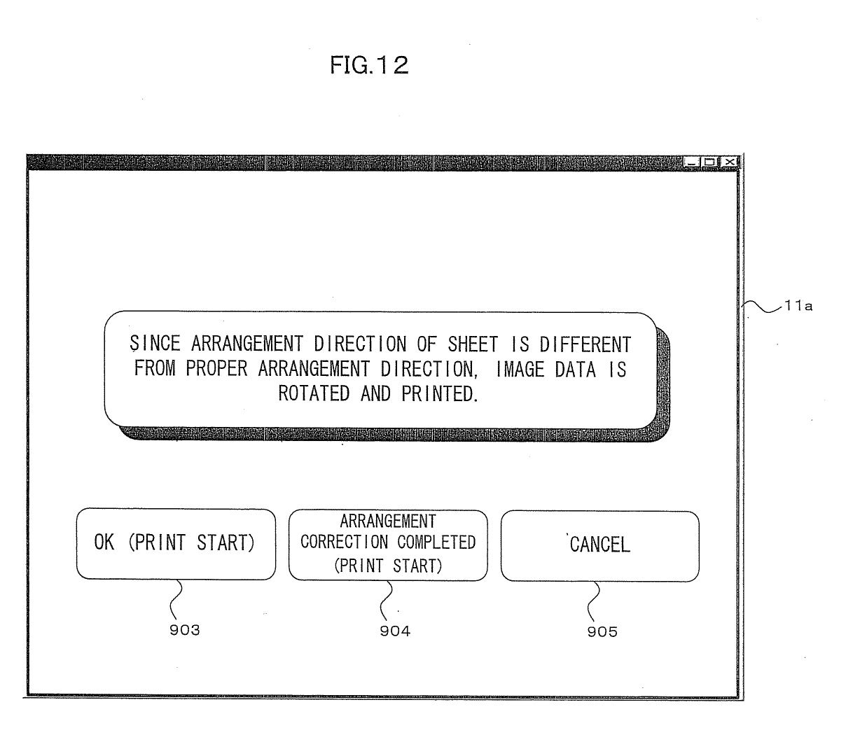

Specifically, as shown in FIG. 12, the processing executing unit 107 notifies, on the display 11a, the user that a method of arranging the sheet set is wrong and provides the user with options described below. When the user depresses an “OK” button 903, the processing executing unit 107 causes the image processing apparatus 21 to rotate image data to be printed according to the direction of the sheet while the arrangement direction of the sheet remains wrong and execute the print processing.

On the other hand, when the user depresses an “Arrangement Correction Completed” button 904, the processing executing unit 107 considers that the direction of the sheet is corrected by the user and causes the image processing apparatus 21 to execute the print processing without changing the direction of the image data to be printed.

When the user depresses a “Cancel” button 905, the print processing is cancelled.

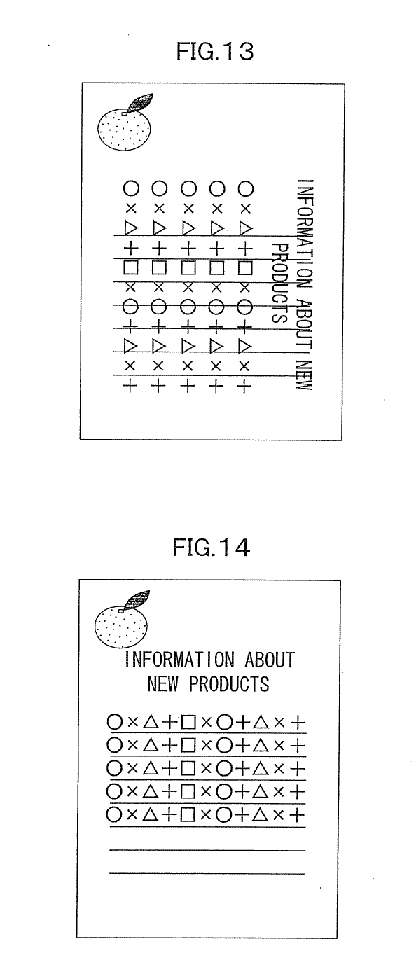

In this way, according to this embodiment, when a sheet having limited arrangement conditions, for example, having a specific image printed on the sheet is used as a recording medium, it is possible to prevent inconsistency of information to be printed and an arrangement of the sheet shown in FIG. 13 caused by an error in a method of setting the sheet and contribute to improvement of operability of a user interface and a reduction in unnecessary print processing. Consequently, as shown in FIG. 14, it is possible to realize appropriate print processing applied to the special sheet.

### Second Embodiment

A second embodiment of the invention will be explained.

This embodiment is a modification of the first embodiment described above. Components having functions same as those of the components already explained in the first embodiment are denoted by the identical reference numerals and signs and explanations of the components are omitted.

In the first embodiment, the example in which the sheet discriminating unit 101, the arrangement-information acquiring unit 102, the arrangement displaying unit 103, the detected-information acquiring unit 104, the arrangement-state determining unit 105, the warning unit 106, the processing executing unit 107, the CPU 801, and the MEMORY 802 are included in the PC 11 is explained. However, the invention is not limited to this. It is also possible to provide the components in the image processing apparatus 21.

Here, it is assumed that it is possible to register setting contents (a setting including a special sheet setting) set on the printer driver screen in the image processing apparatus 21 or the PC 11 in the database 3 in advance.

In the image processing apparatus 21 according to this embodiment, when the printer driver screen is started on the interface screen 211, setting information associated with a user who has succeeded in authentication processing in the authentication processing unit 217 among the setting information stored in the database 3 is acquired.

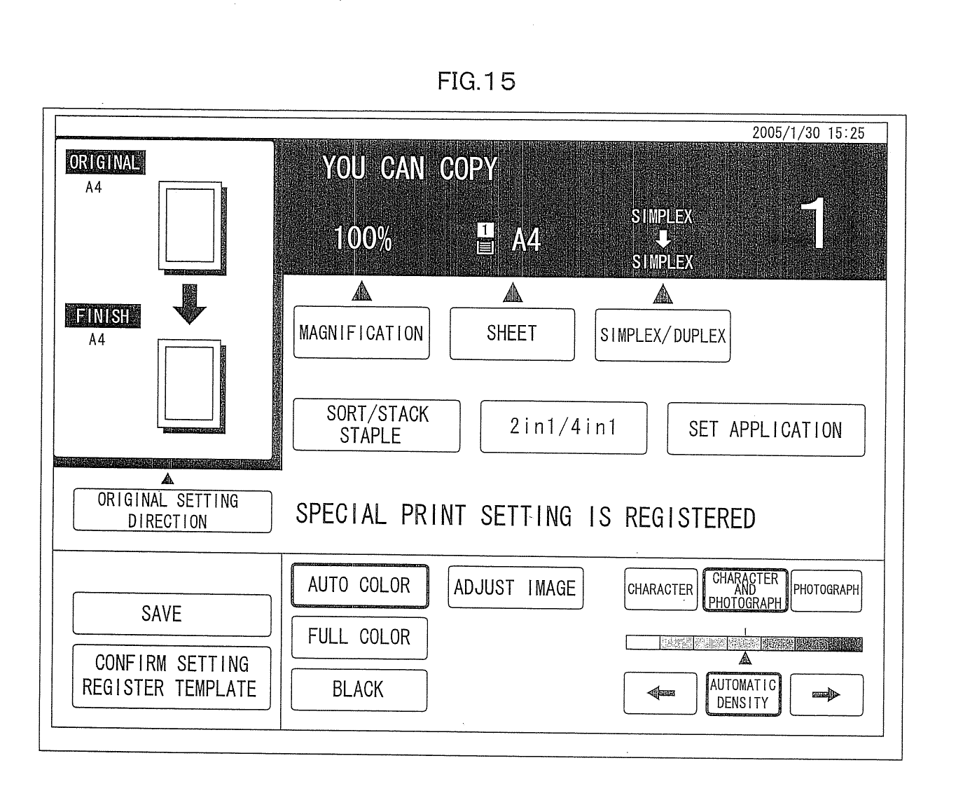

The setting information acquired in this way is reflected on the printer driver screen. FIG. 15 is a diagram showing an example in which an indication that “special print setting” is already registered is displayed in the printer driver screen on the interface screen 211 of the image processing apparatus 21.

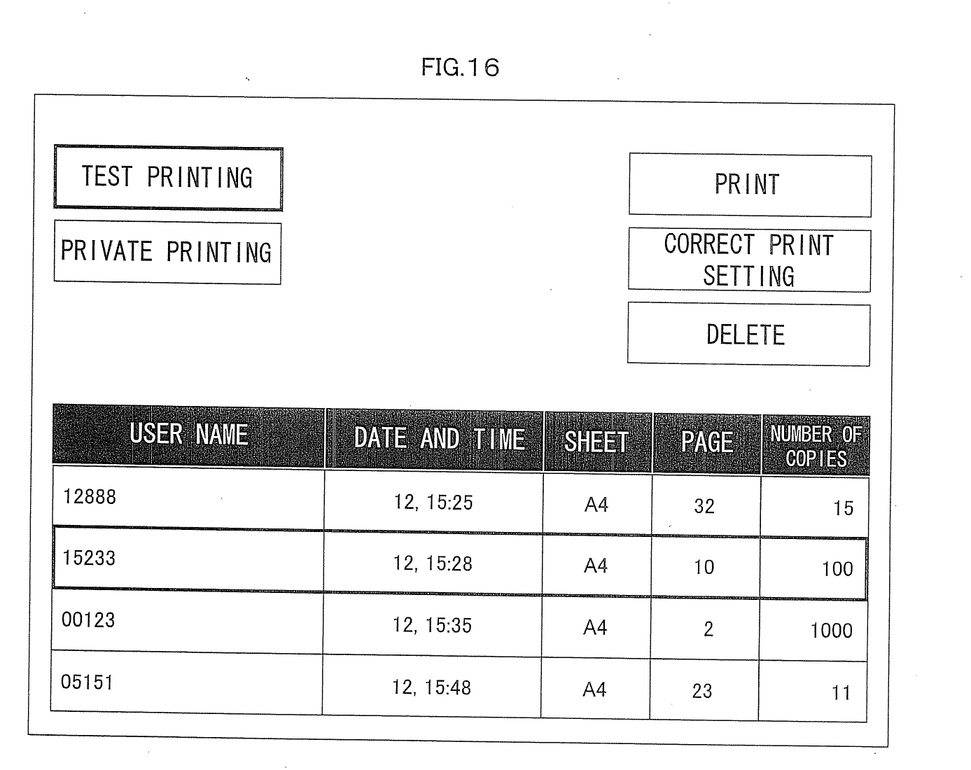

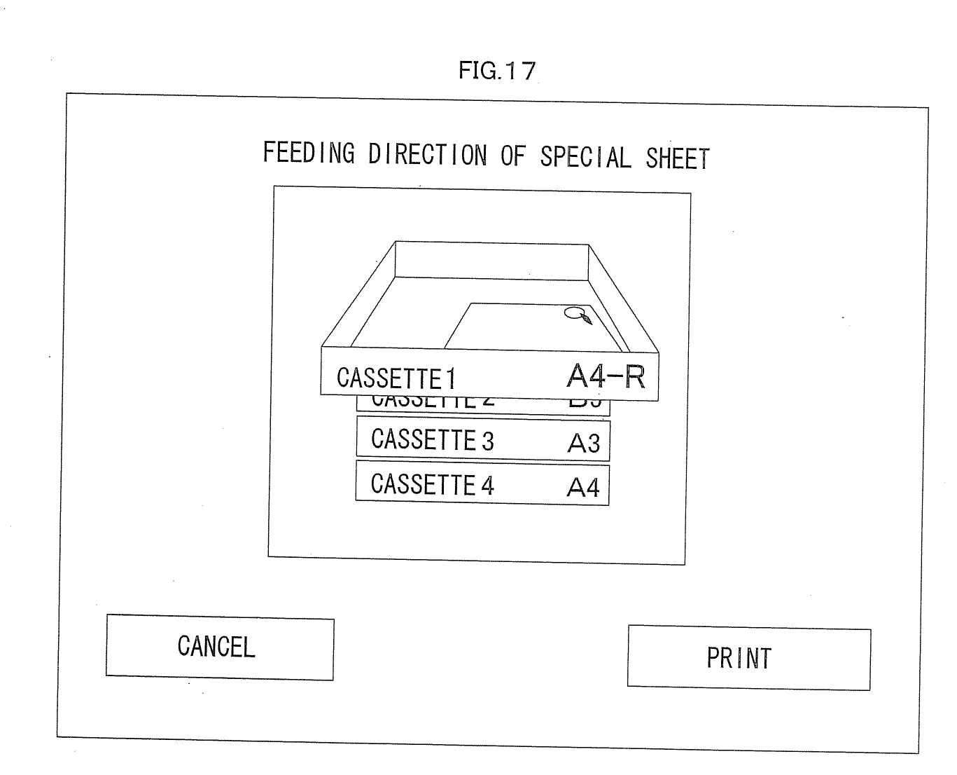

When the user selects a “Setting Confirmation” button or characters “special print setting is registered” on the screen shown in the figure, a list screen shown in FIG. 16 is displayed on the interface screen 211. When the user selects setting contents of the user on this list screen and depresses a “Next” button, a screen shown in FIG. 17 is displayed by the arrangement displaying unit 103.

In this way, according to this embodiment, it is possible to grasp a method of setting the special sheet on the image processing apparatus 21 side on the basis of the special print setting set in the PC 11 or the like in advance. Further, it goes without saying that, according to this embodiment, it is possible to realize functions same as all the functions realized in the first embodiment.

By displaying a direction for placing the special sheet in the cassette or the manual sheet feeding tray on the PC 11 and the image processing apparatus 21, it is possible to visually confirm the direction for placing the special sheet in the cassette or the manual sheet feeding tray during print setting and during sheet supply and it is possible to reduce occurrence of print errors.

In the embodiments described above, the structure for notifying the user of the predetermined arrangement of the sheet through the screen display is cited as the example. However, the invention is not limited to this. It is also possible to notify the user of the predetermined arrangement through, for example, screen display of a sentence that explains arrangement information and sound output (sound indication) performed by using a not-shown speaker. Specifically, when the explanation of the arrangement information is displayed as a sentence, the arrangement displaying unit 103 displays, for example, a sentence “please set a sheet in a position indicated by an arrow with a rear surface upward” on a screen.

In the respective embodiments described above, the example in which a direction of the sheet is determined on the basis of, for example, a difference in a position of an image such as a printed logo is described. However, the invention is not limited to this. For example, information on a distribution of the gloss on a sheet (a sheet partially coated, etc.), a distribution of surface roughness, a non-rectangular shape (a triangle, a trapezoid, a circle, an ellipse, etc.), or the like to determine a direction of the sheet on the basis of the detected information is detected by a media sensor.

In the respective embodiments described above, the “print processing” is cited as the example of the predetermined image processing. However, the invention is not limited to this. The invention is also applicable in various kinds of image processing such as “copy processing”, “scan processing”, and “box processing”. For example, the invention also has an effect when a mark sheet is set in a scanner to scan the mark sheet and when an original or the like having a company name, a logo, and the like printed thereon is transmitted by facsimile in a state in which the original or the like is set in a proper vertical direction.

The respective steps in the processing in the PC 11 described above are realized by causing the CPU 801 to execute a sheet arrangement management program stored in the MEMORY 802.

In the explanation of the embodiments, the functions of carrying out the invention are recorded in the apparatus in advance. However, the invention is not limited to this. The same functions may be downloaded from a network to the apparatus or the same functions stored in a recording medium may be installed in the apparatus. As the recording medium, a form of the recording medium may be any form as long as the recording medium is a recording medium that can store a program and is readable by the apparatus such as a CD-ROM. The functions obtained by the installation or the download in advance in this way may be functions realized in cooperation with an OS (Operating System) or the like in the apparatus.

The invention has been explained in detail according to the specific forms. However, it will be apparent to those having ordinary skill in the art that various modifications and alterations may be made without departing from the spirit and the scope of the invention.

As described above in detail, according to the invention, it is possible to provide a technique that improves, when image processing is applied to a special sheet for which an arrangement method needs to be taken into account, operability of arrangement operation for the special sheet to be printed.

What is claimed is:

1. A driver apparatus that causes an image processing apparatus to execute predetermined image processing on a sheet, the driver apparatus comprising:
a sheet discriminating unit configured to discriminate a type of a sheet to be subjected to the predetermined image processing;
an arrangement-information acquiring unit configured to acquire arrangement information associated with the sheet discriminated by the sheet discriminating unit, the arrangement information being arrangement information concerning a predetermined arrangement in the image forming apparatus of the sheet for causing the image forming apparatus to execute the predetermined image processing; and
an arrangement displaying unit configured to display, on the basis of the arrangement information acquired by the arrangement-information acquiring unit, the predetermined arrangement in the image processing apparatus of the sheet discriminated by the sheet discriminating unit.

2. A driver apparatus according to claim 1, wherein the arrangement displaying unit displays information indicating how the sheet discriminated by the sheet discriminating unit should be arranged with respect to a sheet arrangement position in the image processing apparatus.

3. A driver apparatus according to claim 1, wherein the arrangement displaying unit displays an image indicating a state in which the sheet discriminated by the sheet discriminating unit is arranged in a position where the sheet should be arranged in the image processing apparatus.

4. A driver apparatus according to claim 1, wherein the image of the sheet displayed by the arrangement displaying unit is an image scanned from the sheet.

5. A driver apparatus according to claim 1, comprising:
a detected-information acquiring unit configured to acquire detected information in a media sensor that detects at least one of a reflectance, an electric resistance, a size, thickness, and surface roughness of the sheet arranged in a sheet arrangement position in the image processing apparatus;
an arrangement-state determining unit configured to determine an arrangement state of the sheet on the basis of the detected information acquired by the detected-information acquiring unit; and
a warning unit configured to warn a user when the arrangement state determined by the arrangement-state determining unit is different from the predetermined arrangement.

6. A driver apparatus according to claim 1, wherein the predetermined image processing is print processing.

7. A driver apparatus according to claim 6, comprising:
a detected-information acquiring unit configured to acquire detected information in a media sensor that detects at least one of a reflectance, an electric resistance, a size, thickness, and surface roughness of the sheet arranged in a sheet arrangement position in the image processing apparatus;
an arrangement-state determining unit configured to determine an arrangement state of the sheet on the basis of the detected information acquired by the detected-information acquiring unit; and
a processing executing unit configured to cause, when the arrangement state determined by the arrangement-state determining unit is different from the predetermined arrangement, the image processing apparatus to rotate, according to the arrangement state of the sheet, an image that should be formed on the sheet and execute the print processing.

8. A sheet arrangement management method for managing, in a driver apparatus that causes an image processing apparatus to execute predetermined image processing on a sheet, a sheet arrangement in the image processing apparatus, the sheet arrangement management method comprising the steps of:
discriminating a type of a sheet to be subjected to the predetermined image processing;
acquiring arrangement information associated with the sheet discriminated in the sheet discriminating step, the arrangement information being arrangement information concerning a predetermined arrangement in the image forming apparatus of the sheet for causing the image forming apparatus to execute the predetermined image processing; and
displaying, on the basis of the arrangement information acquired in the arrangement-information acquiring step, the predetermined arrangement in the image processing apparatus of the sheet discriminated in the sheet discriminating step.

9. A sheet arrangement management method according to claim 8, wherein, in the arrangement displaying step, information indicating how the sheet discriminated in the sheet discriminating step should be arranged with respect to a sheet arrangement position in the image processing apparatus is displayed.

10. A sheet arrangement management method according to claim 8, wherein, in the arrangement displaying step, an image indicating a state in which the sheet discriminated in the sheet discriminating step is arranged in a position where the sheet should be arranged in the image processing apparatus is displayed.

11. A sheet arrangement management method according to claim 8, wherein the image of the sheet displayed by the arrangement displaying step is an image scanned from the sheet.

12. A sheet arrangement management method according to claim 8, comprising the steps of:
acquiring detected information in a media sensor that detects at least one of a reflectance, an electric resistance, a size, thickness, and surface roughness of the sheet arranged in a sheet arrangement position in the image processing apparatus;
determining an arrangement state of the sheet on the basis of the detected information acquired in the detected-information acquiring step; and
warning a user when the arrangement state determined in the arrangement-state determining step is different from the predetermined arrangement.

13. A sheet arrangement management method according to claim 8, wherein the predetermined image processing is print processing.

14. A sheet arrangement management method according to claim 13, comprising the steps of:
acquiring detected information in a media sensor that detects at least one of a reflectance, an electric resistance, a size, thickness, and surface roughness of the sheet arranged in a sheet arrangement position in the image processing apparatus;
determining an arrangement state of the sheet on the basis of the detected information acquired in the detected-information acquiring step; and
causing, when the arrangement state determined in the arrangement-state determining step is different from the predetermined arrangement, the image processing apparatus to rotate, according to the arrangement state of the sheet, an image that should be formed on the sheet and execute the print processing.

15. A sheet arrangement management program for causing a computer to execute, in a driver apparatus that causes an image processing apparatus to execute predetermined image processing on a sheet, management of a sheet arrangement in the image processing apparatus, the sheet arrangement management program causing the computer to execute:
a sheet discriminating step of discriminating a type of a sheet to be subjected to the predetermined image processing;
an arrangement-information acquiring step of acquiring arrangement information associated with the sheet discriminated in the sheet discriminating step, the arrangement information being arrangement information concerning a predetermined arrangement in the image forming apparatus of the sheet for causing the image forming apparatus to execute the predetermined image processing; and
an arrangement displaying step of displaying, on the basis of the arrangement information acquired in the arrangement-information acquiring step, the predetermined arrangement in the image processing apparatus of the sheet discriminated in the sheet discriminating step.

16. A sheet arrangement management program according to claim 15, wherein, in the arrangement displaying step, information indicating how the sheet discriminated in the sheet discriminating step should be arranged with respect to a sheet arrangement position in the image processing apparatus is displayed.

17. A sheet arrangement management program according to claim 15, wherein, in the arrangement displaying step, an image indicating a state in which the sheet discriminated in the sheet discriminating step is arranged in a position where the sheet should be arranged in the image processing apparatus is displayed.

18. A sheet arrangement management program according to claim 15, wherein the image of the sheet displayed by the arrangement displaying step is an image scanned from the sheet.

19. A sheet arrangement management program according to claim 15, comprising:
a detecting step of detecting at least one of a reflectance, an electric resistance, a size, thickness, and surface roughness of the sheet arranged in a sheet arrangement position in the image processing apparatus;
an arrangement-state determining step of determining an arrangement state of the sheet on the basis of the detected information in the detecting step; and
a warning step of warning a user when the arrangement state determined in the arrangement-state determining step is different from the predetermined arrangement.

20. A sheet arrangement management program according to claim 15, wherein
the predetermined image processing is print processing, and
the sheet arrangement management program includes:
a detecting step of detecting at least one of a reflectance, an electric resistance, a size, thickness, and surface roughness of the sheet arranged in a sheet arrangement position in the image processing apparatus;
an arrangement-state determining step of determining an arrangement state of the sheet on the basis of the detected information in the detecting step; and
a processing executing step of causing, when the arrangement state determined in the arrangement-state determining step is different from the predetermined arrangement, the image processing apparatus to rotate, according to the arrangement state of the sheet, an image that should be formed on the sheet and execute the print processing.
